(19) United States
(12) Patent Application Publication
(10) Pub. No.: US 2024/0408833 A1
(43) Pub. Date: Dec. 12, 2024

(54) PLASTIC MATERIAL, AND METHOD FOR PROCESSING A PLASTIC MATERIAL

(71) Applicant: AIXLens GmbH, Alsdorf (DE)

(72) Inventors: Reinhart Poprawe, Aachen (DE); Axel von Wallfeld, Herzogenrath (DE); Uwe Clasen, Aachen (DE)

(21) Appl. No.: 18/712,075

(22) PCT Filed: Aug. 16, 2022
(86) PCT No.: PCT/DE2022/000093

§ 371 Date: May 21, 2024

(30) Foreign Application Priority Data
Nov. 25, 2021 (DE) 10 2021 005 859.3
Feb. 22, 2022 (DE) 10 2022 000 647.2

(51) Int. Cl. B29D 11/00; B29K 33/00

(52) U.S. Cl. CPC B29D 11/00038; B29C 2793/0027; B29K 2033/00

(57) ABSTRACT

Exemplary arrangements include articles and methods of producing plastic material objects. Such objects may be configured for use as an ocular implant, and intraocular lens, or a contact lens. Exemplary methods include ablating and polishing plastic material in a processing region of a plastic material object through operation of at least one laser such that some material in the region is de-crosslinked. Exemplary methods also include subsequently irradiating the processing region to at least partially re-cross-link the plastic material.

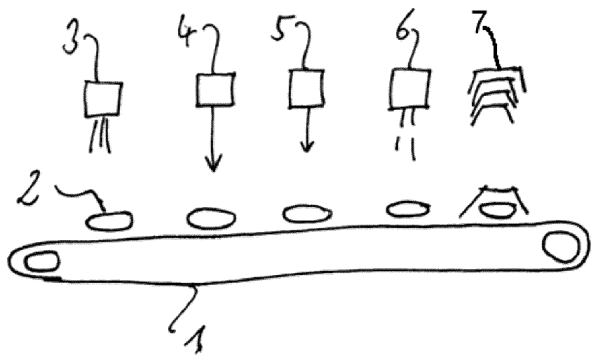

### TECHNICAL FIELD

Exemplary arrangements relate to methods for processing a plastic material, in which the plastic material is processed with a laser and then irradiated. Exemplary arrangements relate to methods of making articles configured to be used as an ocular implant, an intraocular lens or a contact lens, and such articles produced via the methods.

### BACKGROUND

Methods for processing plastic materials and particularly in processing plastic materials to produce articles comprised of plastic and that are configured to be used as an ocular implant, an intraocular lens or a contact lens, may benefit from improvements.

### SUMMARY

Exemplary arrangements relate to plastic articles and methods of producing plastic material objects configured to be used as an ocular implant, an intraocular lens or a contact lens. Exemplary methods used may include ablating plastic material in a processing region of a plastic material object through operation of at least one laser, which causes at least some of the plastic material remaining in the processing region to be de-crosslinked. Either concurrently with or subsequent to ablating the plastic material, polishing plastic material in the processing region through operation of the at least one laser. Subsequent to polishing, irradiating plastic material in the processing region, such that the plastic material in the processing region at least partially regains crosslinking. Further aspects of exemplary arrangements are explained in the following detailed description.

### BRIEF DESCRIPTION OF DRAWING

The FIGURE diagrammatically shows a side view of a processing unit which may be used to carry out exemplary methods and to produce exemplary articles as described herein.

### DETAILED DESCRIPTION

In exemplary arrangements, when ablating plastic material above the vaporization threshold or during modification of a material below the vaporization threshold, depending on the type of the plastic material and the processing parameters, in particular in the case of thermosets, de-crosslinking or depolymerization of the plastic material may occur, which has a negative impact on the properties of the plastic material. This affects mechanical and chemical properties such as strength, elasticity, fatigue strength under cyclic bending stresses, inertness and solubility. Furthermore, a plastic material, in particular an ocular implant or an intraocular lens, may have at least one region in which plastic material has been vaporized or modified using a laser.

Treating plastic materials with a laser in order to remove material and/or to polish the surface may be done in a known manner. An example of this type of processing of a plastic material is shown in DE 10 2017 002 986 B4 which corresponds to U.S. Pat. No. 11,786,994 which is incorporated herein by reference in its entirety. There, an intraocular lens is used by way of example to show how material can be ablated with a laser and in addition, how polishing of the surface can also be carried out with the laser.

US 2017/0371180 A1, which is also incorporated herein by reference in its entirety, describes a method for the manufacture of a contact lens, in which an internal cavity in the contact lens is filled with a water-soluble polymer. To this end, a hole is drilled with a laser from the outside of the contact lens to the cavity and the water-soluble material in the cavity is then rendered soluble with UV light. Finally, the hole is closed up again.

However, exemplary arrangements not only relate to the treatment of intraocular lenses, ocular implants, methacrylate plastic materials or thermoplastics, but in general to the treatment of plastic material in which the plastic material is processed with a laser.

The laser processing methods for vaporizing plastic material or even only for modifying or melting plastic material, modify the crosslinking of the molecules in the plastic material. This also modifies the properties of the remaining plastic material at least in the region in which the plastic material has been processed. This is particularly pertinent to the geometry in the case of ablation and in the case of melting. During melting and modification, however, the mechanical and chemical properties are also modified, particularly also the refractive index at the surface or in the volume of the plastic material.

In the context of this disclosure, the term “plastic material object” should be understood to mean a solid object the basic component of which is formed by synthetically or semi-synthetically produced polymers with organic groups. Synthetic plastic materials are produced from monomers by polymerization (polyaddition, polycondensation, etc).

During the thermal treatment of plastic materials, in particular such as during melting and vaporization, or indeed in order to modify the refractive index in the material, the degree of crosslinking is reduced. This changes physical material properties of the material in that it drops the hardness, lowers the toughness and the melting point, and the solubility increases. This facilitates the processing of the plastic material and this enables a blank, for example, or a blank which has been pre-treated with a laser, to be further processed with a polishing laser.

After polishing the blank with a polishing laser, however, the plastic material still has a lower degree of crosslinking than the untreated blank. This results in the plastic material no longer being as hard and tough as the untreated blank.

Thus, a useful aspect of exemplary arrangements is to process or post-process plastic materials in a manner such that the disadvantages associated with the de-crosslinking of the plastic material are compensated for or at least minimized.

It has been found that even a variation of the method for ablation, melting or modification of the plastic material, even with the aid of ultrashort pulse (USP) lasers with pulse durations of less than 1 ns and pulse energies of 0.1 μJ to 10 μJ, has a deleterious effect on the processed plastic material. Instead of optimizing the process method more and more, in the exemplary arrangements described herein the plastic material can be irradiated after the laser processing in order to at least partially re-crosslink the plastic material.

Particle bombardment in the form of beams are suitable for the irradiation. Electron beams, gamma radiation or photon beams, in particular UV photon beams, may be used as the particle beams. The radiation activates the de-crosslinked polymer chain portions in the form of electronic excitation or ionization, which then lead to increased crosslinking with other polymer chain portions. Tests in which the particle energy and the particle beam power with respect to the incident power per unit area are varied confirm the effect.

In contrast to previous approaches, then, in accordance with exemplary arrangements described herein, a method for reducing the de-crosslinking of the plastic material during laser processing is not used, but rather, the de-crosslinking of the plastic material during processing with the laser is accepted and the plastic material is subsequently irradiated in order to at least partially re-crosslink the plastic material. In this manner, the de-crosslinking of the processed plastic material object blank can be reduced, the plastic material can regain the preprocessing physical material properties of the blank after it has been laser processed, and even an increased crosslinking compared with the degree of crosslinking of the original blank can be obtained, in order to increase the hardness, the toughness and the melting point and to reduce the solubility.

Thus in the exemplary arrangements after laser ablation and polishing, the plastic material undergoes a subsequent procedure, with which the reduction in the viscosity generated by previous polishing due to shortening of the polymer chains is turned in the other direction and raised by crosslinking and therefore preferably, the original values for the physical material properties as regards hardness, solubility and toughness are largely regained. This may occur with a lens at its outside surface, but also inside the material of the lens. Additional crosslinking is appropriate because of the polishing process and the reinstatement of the initial properties, as a rule on the surfaces and in particular the outer surfaces, and this can be achieved in an advantageous manner with particle beams.

A possible treatment of the plastic material in some exemplary arrangements in order to increase the crosslinking would be treatment with crosslinking agents. Crosslinking agents of this type are distinguished by at least two reactive groups. Crosslinkers with two identical reactive groups are described as homobifunctional crosslinkers; on the other hand, those with two different groups are described as heterobifunctional crosslinkers.

The crosslinking of extant polymer chains is referred to as curing and may be accomplished either via functional groups which are already present in the polymer by appropriate choice of the reaction conditions, or by using multi-functional, low molecular weight substances.

Depending on the degree of crosslinking, the crosslinking of polymers initially generates elastomers and, with increasing crosslinking, also thermosets.

However, in accordance with some exemplary arrangements, a normal crosslinking agent is not employed, but rather, the plastic material is irradiated following the de-crosslinking. The irradiation enables the plastic material which has been treated with a laser beam to then be treated by specific irradiation which is appropriate for increasing the crosslinking.

While in the case of ablation, melting, polishing or modification, irradiation with the laser leads to de-crosslinking of the plastic material, irradiation with other beams or parameters results in a crosslinking of the plastic material.

Thus, the method in accordance with exemplary arrangements provides that a plastic material can be processed up to vaporization or polishing exclusively by irradiation, and therefore in a contact-free manner, and then, again in a contact-free manner, to regain its hardness or to improve the properties of the material.

In some exemplary arrangements, these steps of the method may be carried out directly one after the other. In other exemplary arrangements, they may be carried out concurrently and in parallel, wherein the de-crosslinking occurs during the processing of the blank with the laser focussed in the internal region of the blank and/or at its surface, and the subsequent irradiation treatment with the particle beam counteracts this de-crosslinking process. In order to be able to process plastic material objects as parts in a continuous process, these may be conveyed on a conveying device through treatment stations such as blank placement, ablation, polishing, crosslinking, final cleaning, final inspection, packaging. However, a stationary plastic material object blank could be processed and irradiated with one laser. This makes it particularly easy to vary the chronological sequencing of the steps of the exemplary method.

The plastic material parts may be heated by the radiation during processing, in order to accelerate the process. However, they may also be heated with separately introduced infrared heating, for example, in particular in order to speed up polishing and/or crosslinking.

In particular, thermosets and thermoplastics which, however, might be crosslinked by the irradiation in a manner such that an elastomer or a thermoset is formed, are suitable for the exemplary methods.

An acrylate or methacrylate is particularly useful as the plastic material for processing with a laser and then with irradiation for regaining the crosslinking.

The described exemplary method is also particularly suitable for the manufacture of ocular implants. The laser processing means that a special implant, and an implant intended for special surgical treatment, can be manufactured from a plastic material object blank and this implant can then be hardened again by crosslinking the plastic material. The contact-free treatment of the plastic material means that a plastic material which is suitable for use as an implant can in fact be de-crosslinked and then re-crosslinked, but in the end has similar or identical crosslinking to that of the starting material. This avoids problems which could arise when a plastic material which is authorized for the manufacture of implants is modified by the treatment with the laser and the associated de-crosslinking such that it is no longer suitable for use as an implant.

Good results have been obtained using the exemplary methods described herein for an ocular implant and in particular for an intraocular lens.

Processing the plastic material with an ultrashort pulse laser (USP laser) is particularly suitable for the processing of a plastic material, because here, a particularly precise modification to the plastic material can be obtained, which modifications may extend from a partial modification to the material properties via a vaporization of regions of the material up to subsequent polishing by melting material on the surface of the plastic material.

In order to be able to manufacture specific plastic objects for use as a mechanical component or as an implant, for example, advantageously, during processing, a portion of the plastic material is vaporized with the laser and/or the refractive index is modified in the interior of the blank. In addition, during processing, the plastic material may be polished with the laser, during which specific regions of the material are ablated or, in addition, liquefaction and therefore an increased surface tension effect is obtained with a view to smoothing in order to prevent microscopic structures from being present on the surface.

A simple processing of the plastic material is obtained when the plastic material is processed with the laser on the surface of the plastic material. Even processing the surface of the plastic material, however, also necessarily results in processing regions of the plastic material which lie beneath the surface in the interior of the plastic material.

In addition to processing of this type near the surface, the laser beam may also be used for specific processing of the plastic material in the interior of the plastic material. This in particular involves regions of the plastic material which are at least 0.2 mm from the surface of the plastic material.

By coordinating the de-crosslinking with the laser and the crosslinking with the irradiation, specific predefined material properties may be set up on a region of the surface or in a region within the volume of the blank.

On the same point, an increase in the de-crosslinking may be compensated for by an increase in the crosslinking, or the desired material properties are achieved by the combination of a defined de-crosslinking and a defined crosslinking.

The defined combination of material properties may, however, also be used to provide de-crosslinking and crosslinking to different extents at different points, surface regions or volumetric regions. This means that the plastic material object blank gains different material properties depending on the particular region of the blank.

As an example, the processed blank may have outer surface regions which are particularly hardened by the irradiation, and internal regions which are less intensively hardened by the irradiation.

In this manner, for example in the case of a lens, in the path of a beam of light passing through the lens, the refractive index in one region may be increased and it could be reduced or increased in another region in order to balance out the change caused by processing of the blank or to obtain a specific refractive index.

As is the case with lasers, the total duration, pulse duration and intensity can be varied, and so these parameters may also be used to vary the effects of the irradiation on the properties of the material in the irradiated region of the plastic material object.

In order to irradiate the plastic material object after de-crosslinking in order to obtain at least partial re-crosslinking of the plastic material, an irradiation with photons is carried out.

An irradiation of the plastic material with electrons, beta radiation or gamma radiation has also been shown to be advantageous in re-crosslinking the plastic material.

In some exemplary arrangements the treatment of plastic materials with high energy electron beams, beta radiation or gamma radiation endows the plastic material employed with the thermal, mechanical and chemical properties of high-performance plastic materials. This means that inexpensive commodity plastics may also be used for the method. Radiation crosslinking may be carried out following shaping, as the last processing step in the process chain. In the particular exemplary processing arrangements, in particular due to the hardness of the surface obtained thereby, the plastic material parts can also be packed loose in pallet cages or cardboard boxes. Because an exact dose of radiation is applied, the crosslinking can be precisely controlled. The material properties can be precisely defined in advance and be achieved by pinpoint-accurate irradiation. Shielding will even enable the degree of crosslinking inside a shaped part to be varied in exemplary arrangements. In this manner, a plastic material part may have different hardnesses.

In contrast to chemical crosslinking processes, radiation crosslinking used in exemplary arrangements takes place at low temperatures; this facilitates processing.

Particularly good results have been obtained with the crosslinking of polyethylene (PE), polyamide (PA), polybutylene terephthalate (PBT) and polyvinyl chloride (PVC). In addition, the exemplary methods described herein are suitable for thermoplastic elastomers (TPE) and polypropylene (PP), but also for thermosets such as methacrylates and polymethacrylates.

The exemplary arrangements therefore also concern an article comprised of a plastic material, in particular an ocular implant or an intraocular lens which has at least one region in which the plastic material has been processed with a laser, and in this regard, de-crosslinking of the plastic material occurs with the laser, and the plastic material is subsequently irradiated in at least one region in order to re-crosslink the plastic material. An example of processing of this type with a laser is the ablation via vaporization of a portion of the plastic material, or in fact polishing of the plastic material by modifying the surface of the plastic material.

In exemplary arrangements plastic materials are polished after the vaporization of a portion of the plastic material and they are subsequently irradiated in order to crosslink the plastic material once again.

The term “plastic material” as used in the context of this disclosure should be understood to mean any plastic materials as raw materials, as shaped parts or any plastic material objects of plastic material parts such as mechanical elements or implants, or in fact also plastic surfaces or regions of plastic material inside another component.

An exemplary arrangement in accordance with the principles described herein is a method for the manufacture of an intraocular lens. This lens is manufactured from a plastic material object which comprises a blank for which initially, an ablation of material is carried out using an ablative laser. In this regard, a region of the blank in which the laser impinges on the blank is vaporized. This exemplary ablation of material of 0.01 to 10 μm/pulse is obtained with a laser with a pulse energy of 0.1 μJ to 10 μJ. The pulse duration of the USP laser in this regard is less than 1 ns and the laser wavelength in the exemplary method is between 193 nm and 370 nm. In the exemplary method the focal diameter is between 5 and 5 μm.

The exemplary blank consisting of an acrylate is then initially shaped by ablation through vaporization of regions of the surface so that it reaches almost the prescribed final shape. Next, the blank is processed further with a polishing laser.

Because this leads to a de-crosslinking in the processing regions, the blank is then treated in at least these regions via irradiation with an electron beam, with a photon beam, with beta radiation or with gamma radiation. The treatment duration is such that the processed surface at least regains the degree of crosslinking of the blank or may even have a higher degree of crosslinking than prior to the ablation step, at least in parts.

This exemplary approach makes it possible to manufacture plastic material parts and also in particular medical implants with a particularly hard and solvent-resistant, and therefore bio-resistant, surface.

The combination of a de-crosslinking method step using a laser and a crosslinking method step by means of a treatment with radiation means that the plastic material part can also be manufactured with different densities. Thus, for example, an intraocular lens manufactured by the method may have a harder, i.e. more crosslinked, layer of plastic material on the surface than in the interior, for protection purposes. Crosslinking gradients may be obtained in a cross section through a plastic material part and because of the prescribed crosslinking, the refractive index in the interior or even inside the lens can be specifically varied.

This enables a beam of light passing through the plastic material object to be influenced not only by means of the material properties and shaping at the surface of the plastic material object and in particular the lens surface, but also by the pre-set material density in the plastic material and in particular also by a density gradient inside the plastic material object.

In an exemplary arrangement, a plastic material object blank is modified during the laser processing and then is irradiated in a manner such that afterwards, the plastic material object once again has the material properties of the plastic material blank prior to laser processing.

The methods described in DE 10 2017 002 986 A1, which corresponds to the disclosure of U.S. Pat. No. 11,786,994 which is incorporated herein by reference in its entirety, are particularly advantageous having regard to processing the plastic material with a laser.

An exemplary arrangement is illustrated in the FIGURE and is further described below.

The single FIGURE diagrammatically shows a side view of an exemplary processing unit.

The conveyor belt schematically shown in the FIGURE conveys lenses 2 (only generically numbered) past a plurality of processing stations. By way of example only, an IR emitter 3, which heats the lens 2, is shown at the first processing station. The next processing station includes a laser 4 which specifically modifies the shape of the lens. Next, there is a processing station with a laser 5, which polishes the surface of the lens. The fourth station includes an emitter 6 for high energy electron beams, beta radiation, photon radiation or gamma radiation. The last station is a packing station 7 at which the lens 3 is packaged in a sterile manner.

As an alternative, the lenses could also be in stationary positions and various processing stations are guided past the lenses. In addition, a combination of these two operational modes could be implemented.

The irradiation which serves for crosslinking may be carried out in some exemplary arrangements with electron beams. In this regard, an electron energy of E=150 keV-300 keV, in the limiting case also up to 1.5 MeV, may be used. The mean power of the electron beam is then, for example, P=1-5 kW.

A useful dose may be PD=50-500 kGy (kilo-Gray). This dose may also be provided in several successively applied doses. To this end, the emitter could pass over the workpiece a number of times so that finally, the desired total dose for obtaining the desired crosslinking has been applied.

In an exemplary arrangement, the irradiated surface A was 2×20 cm. This resulted in intensities I of 0.5 kW/cm²-3 kW/cm². A suitable forward speed for the aforementioned surfaces in the exemplary arrangement was V=3-10 cm/s.

In order to obtain an appropriate intensity per unit area, in the exemplary arrangements the values may be scaled up or down.

In the case of stationary irradiation, appropriate intensities, irradiation durations and dose levels are calculated.

The methods described in DE 10 2017 002 986 A1 which corresponds to U.S. Pat. No. 11,786,994 which is incorporated herein by reference in its entirety, are values for normal processing of a plastic material object blank with a laser. In this regard, de-crosslinking occurs which then ought to be compensated for. On the other hand, by a pre-specified combination of de-crosslinking and crosslinking, the material properties of the plastic material object blank are modified specifically at its surface and optionally also in its internal volume.

The special processing which is described in DE 10 2017 002 986 B4 also describes a process step of de-crosslinking usable in some exemplary arrangements, which is followed by the process step of crosslinking as described herein.

Thus the exemplary arrangements achieve benefits and advantages, eliminate difficulties encountered in the use of prior approaches, and provide the useful results as described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the new and useful features are not limited solely to the exact features that have been shown and described.

Having described features, discoveries, and principles of the exemplary arrangements, the manner in which they are utilized and carried out, and the advantages and useful results attained, the new and useful features, devices, elements, arrangements, articles, parts, combinations, systems, equipment, operations, methods, processes and relationships are set forth in the appended claims.

1.-16. (canceled)

17. A method comprising:
a) ablating plastic material in a processing region of a plastic material object through operation of at least one laser, wherein at least some of the plastic material in the processing region is de-crosslinked,
b) polishing plastic material in the processing region through operation of the at least one laser,
c) subsequent to (b), irradiating plastic material in the processing region, wherein at least some of the plastic material in the processing region at least partially regains crosslinking.

18. The method according to claim 17
wherein in (a) through (c) the processing region is on an outer surface of the plastic material object.

19. The method according to claim 17
wherein in (a) through (c) the plastic material comprises a thermoplastic or a thermoset.

20. The method according to claim 17
wherein in (a) through (c) the plastic material comprises an acrylate.

21. The method according to claim 17
wherein in (a) through (c) the plastic material comprises a methacrylate.

22. The method according to claim 17
wherein subsequent to (c) the plastic material object comprises an ocular implant.

23. The method according to claim 17
wherein subsequent to (c) the plastic material object comprises one of an intraocular lens or a contact lens.

24. The method according to claim 17
wherein in at least one of (a) and (b), the at least one laser comprises an ultrashort pulse (USP) laser.

25. The method according to claim 17
wherein in (a) at least some of the plastic material is vaporized.

26. The method according to claim 17
wherein at least a portion of (a) and at least a portion of (b) are carried out concurrently.

27. The method according to claim 17
wherein (a) is carried out prior to (b).

28. The method according to claim 17
wherein in at least one of (a), (b) and (c), plastic material at a surface of the object and further plastic material below the surface within an interior of the object, are respectively of de-crosslinked, polished and crosslinked.

29. The method according to claim 17
wherein in (c) the plastic material in the processing region is irradiated with at least one particle beam.

30. The method according to claim 17
wherein in (c) the plastic material in the processing region is irradiated by with electrons.

31. The method according to claim 17
wherein in (c) the plastic material in the processing region is irradiated with photons.

32. The method according to claim 17
wherein in (c) the plastic material in the processing region is irradiated with beta radiation.

33. The method according to claim 17
wherein in (c) the plastic material in the processing region is irradiated with gamma radiation.

34. The method according to claim 17
wherein subsequent to (c) the physical material properties of the plastic material object are the same as prior to (a).

35. An article produced by a method comprising:
a) ablating plastic material in a processing region of a plastic material object through operation of at least one laser, wherein at least some of the plastic material in the processing region is de-crosslinked,
b) polishing plastic material in the processing region through operation of the at least one laser,
c) subsequent to (b), irradiating plastic material in the processing region, wherein at least some of the plastic material in the processing region at least partially regains crosslinking.

36. An article comprising:
a plastic body configured to be used as one of an ocular implant, an intraocular lens or a contact lens, wherein the plastic body includes
a laser ablation formed and polished, and subsequently irradiated, processing region,
wherein the processing region comprises irradiation crosslinked plastic.
